(19) United States
(12) Patent Application Publication
(10) Pub. No.: US 2019/0234494 A1
(43) Pub. Date: Aug. 1, 2019

(54) VARIABLE FORCE TENSIONER WITH SECONDARY PISTON RATCHET CLIP

(71) Applicant: BorgWarner Inc., Auburn Hills, MI (US)

(72) Inventors: Keith B. COBB, Cortland, NY (US); Kevin B. TODD, Freeville, NY (US); Robert G. WILLIAMSON, Breesport, NY (US)

(21) Appl. No.: 16/262,999

(22) Filed: Jan. 31, 2019

Related U.S. Application Data
(60) Provisional application No. 62/624,241, filed on Jan. 31, 2018.

(51) Int. Cl. F16H 7/08; F01L 1/02

(52) U.S. Cl. CPC F16H 7/0836; F01L 1/022; F16H 2007/0891; F16H 2007/0812; F16H 2007/0846; F16H 2007/0806

(57) ABSTRACT

In order to prevent noise, a ratchet clip and grooves for the ratchet clip to engage are added to the second piston, such that the second piston cannot hit the bottom of the second bore housing. The second piston is prevented from hitting the bottom of the second bore housing by the ratchet clip engaging the ratchet grooves on the outer circumference of the second piston.

### REFERENCE TO RELATED APPLICATIONS

This application claims one or more inventions which were disclosed in Provisional Application No. 62/624,241, filed Jan. 31, 2018, entitled “VARIABLE FORCE TENSIONER WITH SECONDARY PISTON RATCHET CLIP”. The benefit under 35 USC § 119(e) of the United States provisional application is hereby claimed, and the aforementioned application is hereby incorporated herein by reference.

### BACKGROUND OF THE INVENTION

### Field of the Invention

The invention pertains to the field of hydraulic tensioners. More particularly, the invention pertains to a tensioner with spring force control in a second bore of the housing.

### Description of Related Art

Generally, in timing chains for valve drives of internal combustion engines, camshaft chains in use for a camshaft-camshaft drive, and balancer chains, tensioners are used on the slack side of a chain to take up slack in the chain and to apply tension to the chain.

During operation, a piston of the tensioner presses a sliding surfaces such as a tensioner arm or shoe against the chain to maintain tension in the chain. When dynamic tension in the chain increases during operation due to resonances in the chain drive, a dynamic load from the chain acts on the piston of the tensioner, causing the piston to extend as the tensioner pumps up to keep the tension in the chain.

Chain drive tensioner spring force is often too high for normal operating conditions because the spring force needs to be sufficient to handle worst case operating conditions of the tensioner system. The effectiveness of the tensioner and the overall system behavior and efficiency could be improved if the tensioner spring force could be varied with operating conditions, taking into account wear and stretching that occurs in the chain during the life of the chain.

FIGS. 1-3 show a prior art dual hydraulic tensioner. The tensioner tensions the chain or belt (not shown) through a tensioner arm or shoe 402. The tensioner arm 402 has a first sliding surface 402b in contact with the chain or belt and a second surface 402a opposite the first sliding surface 402b.

The tensioner includes a housing 102 having a first axially extending bore 102a parallel to a second axially extending bore 102c. Slidably received within the first axially extending bore 102a is a first piston 103. The first piston 103 has a body with a first end 103a, a second end 103c, an outer circumference 103d and a hollow interior 103b with a closed interior first end 103f. The outer circumference 103d has a series of ratchet grooves 112 along the length of the body, with a stop groove 113 near the second end 103c being larger than the ratchet grooves 112 and capturing a ratchet clip 170. The ratchet clip 170 is an expandable clip that ratchets in and out of the ratchet grooves 112 as the first piston 103 moves away from the housing 102. The ratchet clip 170 prevents the first piston 103 from moving towards the housing 102 when the tensioner arm or shoe 402 pushes on the first piston 103.

Present within the hollow interior 103b of the first piston 103 is a first piston spring 104. The first piston spring 104 has a first end 104a in contact with the closed interior first end 103f of the first piston 103 or a volume reducer or vent (not shown) and a second end 104b in contact with a bottom 102b of the first axially extending bore 102a of the housing 102 or a check valve, such as check valve 108. A first pressure chamber 111 is formed between the first piston 103 and the first axially extending bore 102a. Fluid is supplied to the first pressure chamber 111 through a first supply 106 through an inlet check valve 108. The first piston 103 is biased outwards from the housing 102 to bias the chain (not shown) through the first end 103a of the first piston 103, through the tensioner arm 402 by the force of the first piston spring 104 and the pressure of oil in the first pressure chamber 111.

The second axially extending bore 102c slidably receives a second piston 160. The second piston 160 has a body with a first end 160a, a second end 160c, and a hollow interior 160b with a closed first end 160d.

Present within the hollow interior 160b is a second piston spring 166 for biasing the second piston 160 outwards from the housing 102. The second piston spring 166 has a first end 166a in contact with the closed first end 160d of the interior 160b of the second piston 160 and a second end 166b in contact with the bottom 102d of the second axially extending bore 102c. Alternatively, the first end 166a of the spring 166 can contact a volume reducer or vent within the hollow interior 160b of the second piston 160. In another embodiment, the second end 166b of the spring 166 can contact a check valve, such as inlet check valve 107.

An external spring 404 is present between the first end 160a of the second piston 160 and the second flat surface 402a of the tensioner arm 402 with the first end 404a of the external spring 404 in contact with a cavity 402c of the tensioner arm 402 and the second end 404b of the external spring 404 in contact with the first end 160a of the second piston 160. The movement of the second piston 160 moves the second end 404b of the external spring 404 outwards from the housing 102.

A second high pressure chamber 167 is formed by the hollow interior 160b and the second axially extending bore 102c, within which is the second piston spring 166. Fluid is supplied to the second high pressure chamber 167 through an inlet supply 109 and preferably a check valve 107.

When the tensioner is tensioning a new chain or belt, during operation, fluid is supplied to the first pressure chamber 111 from the first inlet supply 106 and through an inlet check valve 108. The pressurized fluid biases the first piston 103 outwards from the housing 102 in addition to the spring force of the first piston spring 104, and also moves the ratchet clip 170 within the ratchet grooves 112, applying tension to a span of the closed loop chain or belt through a tensioner arm 402. At the same time, the second piston 160 is also biased outwards from the second axially extending bore 102c by the second piston spring 166 and fluid supplied to the second pressure chamber 167 from the second inlet supply 109 and through inlet check valve 107, which applies tension to a span of the closed loop chain or belt through the tensioner arm through external spring 404.

When the tensioner is tensioning a worn chain or belt without high load, during operation, fluid is supplied to the first pressure chamber 111 through the first inlet supply 106 and through an inlet check valve 108. The pressurized fluid biases the first piston 103 outwards from the housing 102 in addition to the spring force of the first piston spring 104, applying tension to a span of the closed loop chain or belt through the tensioner arm 402. At the same time, the second piston 260 is also biased outwards further through the second piston spring 266. Tension is also maintained by the external spring 404 on the tensioner arm 402. As the chain or belt wears further, additional slack is present in the chain or belt span, so that the first piston 103 and second piston 160 would need to be extended further outwards from the housing 102 to adequately tension the chain or belt.

When the tensioner is tensioning a chain or belt during high dynamic chain load, the high cyclic dynamic load force from the chain or belt alternately pushes the first piston 103 and the second piston 160 inwards towards the housing 102 and then outwards from the housing 102. During the high tension portion of the tension cycle, inward movement of the second piston 160 is resisted by fluid pressure in the second pressure chamber 167 created by check valve 107. During the low tension portion of the tension cycle the second piston 160 moves outward by the force of spring 166. This causes the piston to “pump up”, drawing fluid through check valve 107 into the second pressure chamber 167 in the second bore 102c. This in turn causes the first end 160a of the second piston 160 to exert an outward force on the tensioner arm 402 through the external spring 404. Excessive inwards movement of the first piston 103 is prevented by the ratchet clip 170 seating in a ratchet groove 112.

When oil is present, the “pump” up action of the first piston 103 is similar to the second piston 160. When oil is present, the ratchet clip 170 prevents excessive piston motion. The ratchet clip 170 also prevents inward motion of the first piston 103 when no oil is present. This will limit the motion of the tensioner arm 402 and the second piston 160.

When the dynamic chain or belt load decreases, fluid within the second pressure chamber 167 leaks to the engine through the second axially extending bore 102c or through a vent. This leakage reduces the mean pressure present within the second pressure chamber 167.

It should be noted that at all operating conditions, the pressure in the second pressure chamber 167 will pump up to maintain a minimum preload in the external spring 404. When the force or preload in the external spring 404 gets too low, the second piston 160 moves out from the housing, due to the second piston spring 166 and pressure in the second pressure chamber 167 and draws more oil in through the inlet check valve 107.

Therefore, the first piston 103 in the first axially extending bore 102a provides the dominant damping and hydraulic stiffness and the second piston 160 in the second axially extending bore 102c provides the dominant and automatically adjusting spring force through the external spring 404. The tensioner of the present invention automatically adjusts the mean tension force to keep the chain or belt tension as low as possible without sacrificing chain or belt control.

### SUMMARY OF THE INVENTION

In an embodiment of the present invention, a ratchet clip and grooves for the ratchet clip to engage are added to the second piston, such that the second piston cannot hit the bottom of the second bore housing. The second piston is prevented from hitting the bottom of the second bore housing by the ratchet clip engaging the ratchet grooves on the outer circumference of the second piston.

### BRIEF DESCRIPTION OF THE DRAWING

FIG. 1 shows a perspective view of a prior art dual hydraulic tensioner.

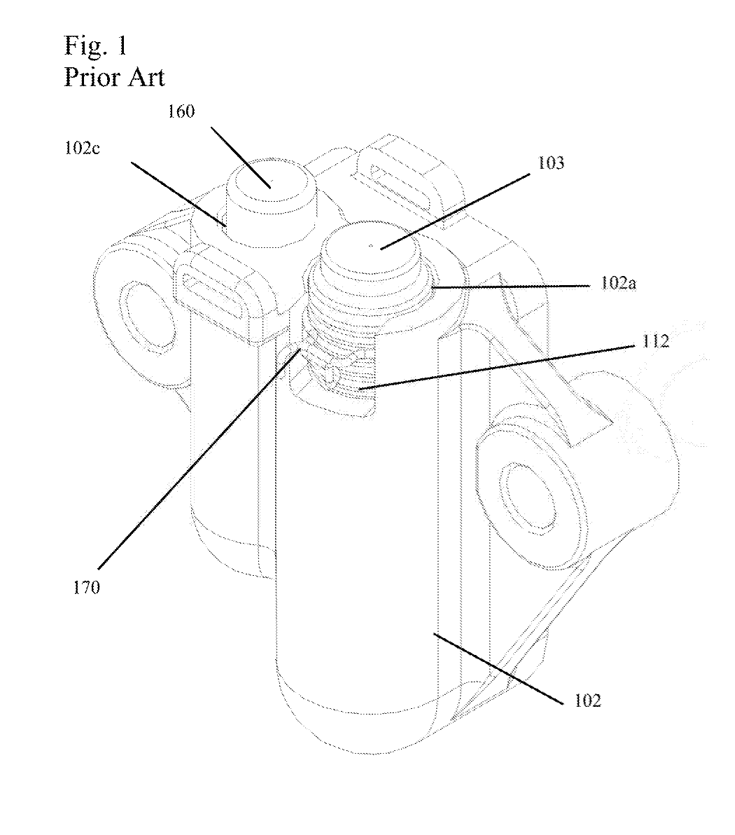

FIG. 2 shows a front view of the prior art dual hydraulic tensioner of FIG. 1.

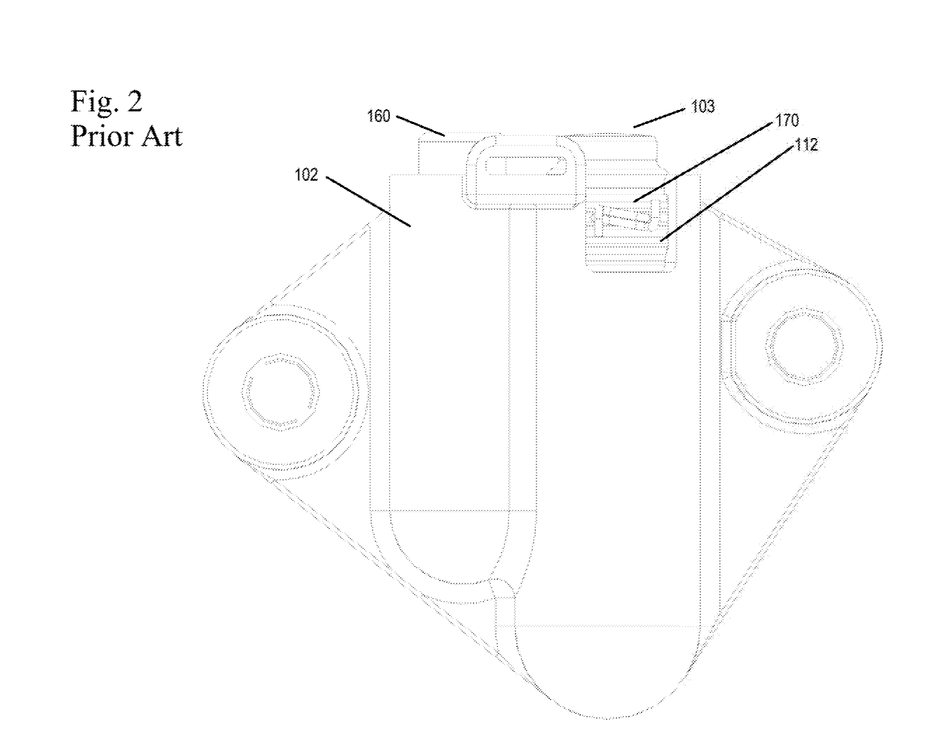

FIG. 3 shows a sectional view of the prior art dual hydraulic tensioner of FIG. 2.

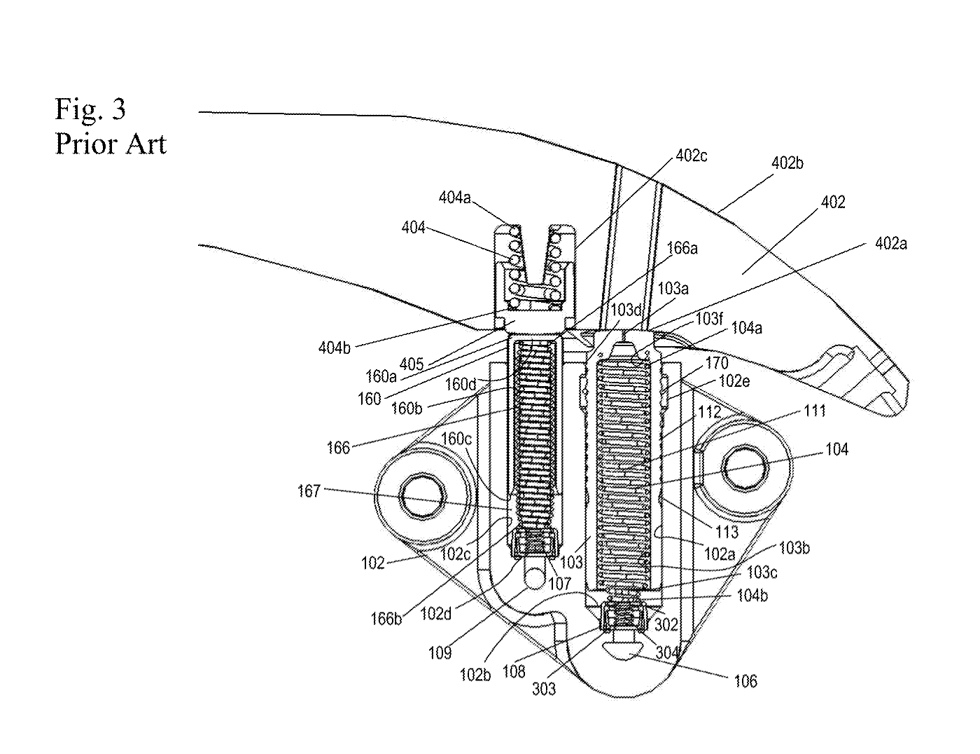

FIG. 4 shows a perspective view of a dual hydraulic tensioner of an embodiment of the present invention.

FIG. 5 shows an alternate perspective view of the dual hydraulic tensioner of an embodiment of the present invention.

FIG. 6 shows a close-up of the second piston and the associated ratchet clip of the dual hydraulic tensioner.

FIG. 7 shows a sectional view of the dual hydraulic tensioner of an embodiment of the present invention with a tensioner arm.

### DETAILED DESCRIPTION OF THE INVENTION

During engine startup or engine failure, there is a lack of inlet oil pressure available to provide to the second high pressure chamber of the second piston and the second piston can bottom out or hit the bottom of the second bore housing in which the second piston is located. The hitting of the second piston on the bottom of the second bore can cause significant noise.

In an embodiment of the present invention, in order to minimize noise, a ratchet clip and grooves for the ratchet clip to engage are added to the second piston, such that the second piston is prevented from hitting the bottom of the second bore housing by the ratchet clip engaging the ratchet grooves on the outer circumference of the second piston.

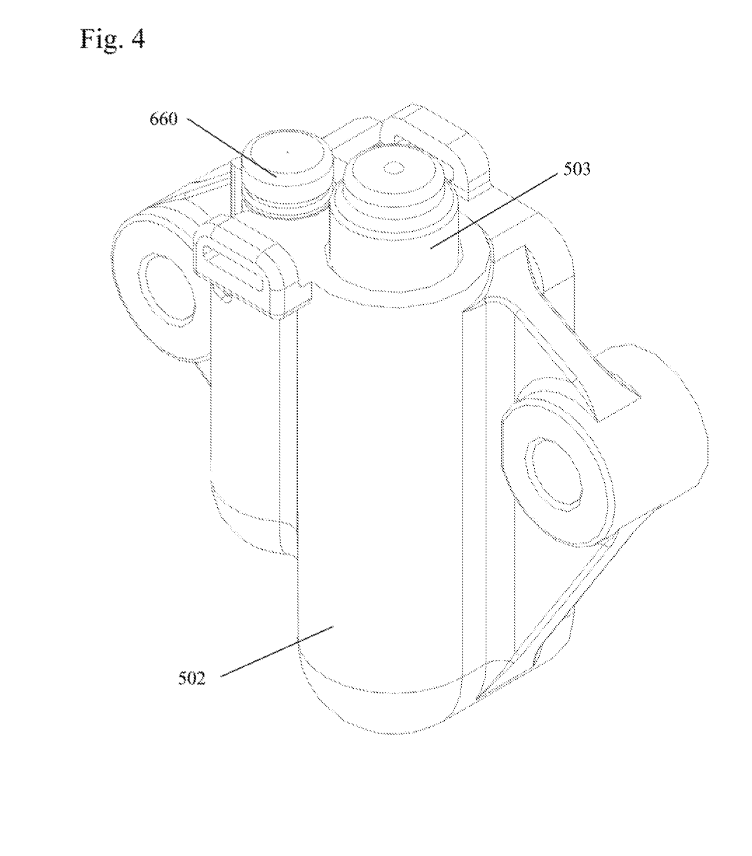

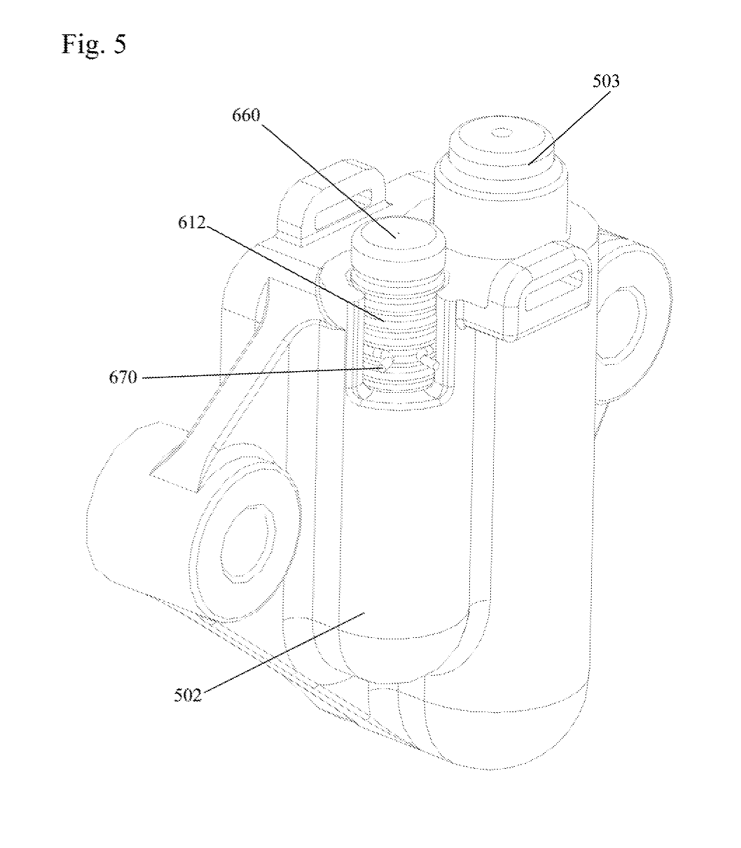

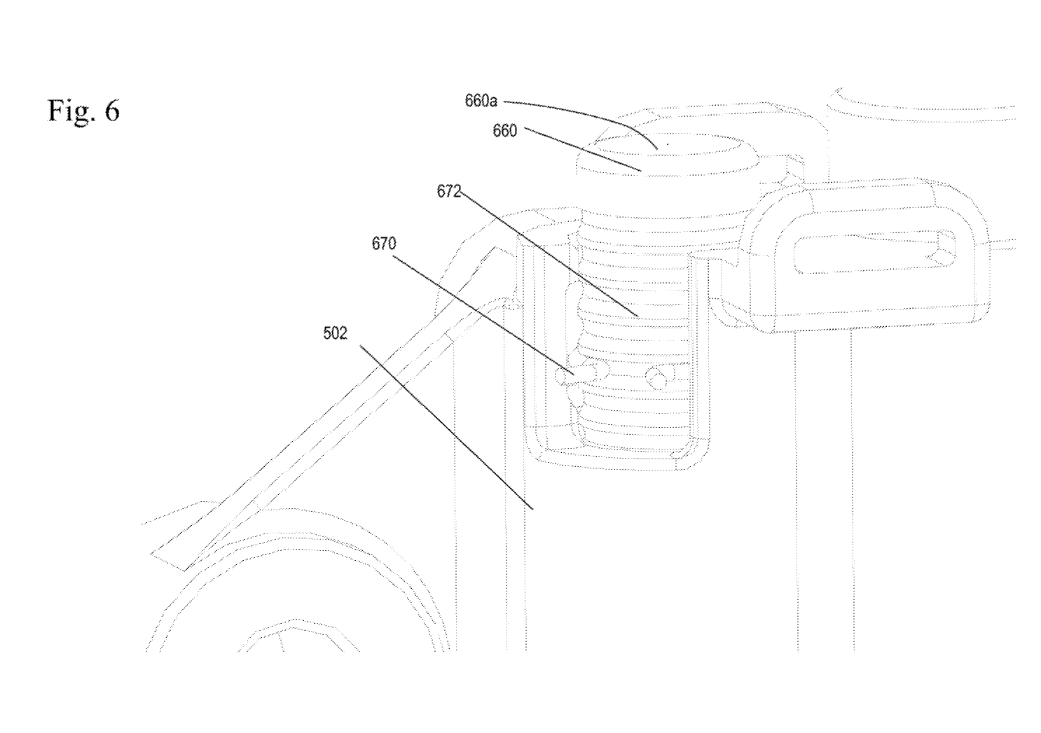

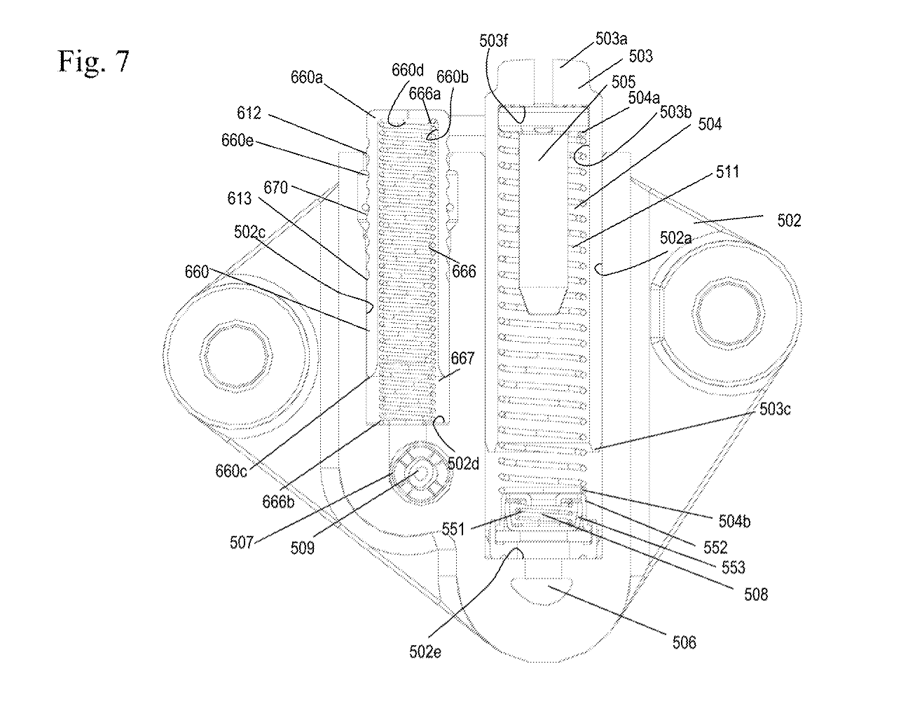

FIGS. 4-7 show tensioners using a passive control system to maintain tension of a chain span or belt. Passive control is defined as a system in which no feedback and a controlled actuator is used to regulate the position of the tensioner pistons.

The tensioner systems of the present invention include a tensioner (described in further detail below) for a closed loop chain or belt drive system as might be used in an internal combustion engine. It may be utilized on a closed loop power transmission system between a driveshaft and at least one camshaft or on a balance shaft system between the driveshaft and a balance shaft. The tensioner system may also include an oil pump and may also be used with fuel pump drives. Additionally, the tensioner system of the present invention may also be used with belt drives.

The tensioner tensions the chain or belt (not shown) through a tensioner arm or shoe 402.

The tensioner includes a housing 502 having a first axially extending bore 502a parallel to a second axially extending bore 502c. While the second bore 502c of the housing 502 is shown as being parallel to the first bore 502a, the second bore 502c may be perpendicular to the first bore 502a or at some other angle relative to the first bore 502a.

Slidably received within the first axially extending bore 502a is a first piston 503. The first piston 503 has a body with a first end 503a, a second end 503c, and a hollow interior 503b with a closed interior first end 503f. Present within the hollow interior 503b of the first piston 503 is a first piston spring 504. The first piston spring 504 has a first end 504a in contact with the closed first end 503d of the first piston 503 or a volume reducer or vent 505 and a second end 504b in contact with an inlet check valve 508 or bottom 502e of the bore 502a. A first pressure chamber 511 is formed between the first piston 503 and the first axially extending bore 502a. Fluid is supplied to the first pressure chamber 511 through a first supply 506 through an inlet check valve 508. The inlet check valve 508 may be formed of a retainer 552 containing a spring 551 biased cup 553. The first piston 503 is biased outwards from the housing 502 to bias the chain (not shown) through the first end 503a of the first piston, through the tensioner arm by the force of the first piston spring 504 and the pressure of oil in the first pressure chamber 511.

Alternatively, the first piston 503 could be solid, and in that case the first piston spring 504 would contact a bottom of the solid body of the first piston 503 and the bottom 502b of the first axially extending bore 502a or the inlet check valve 508.

The second axially extending bore 502c slidably receives a second piston 660. The second piston 660 has a body with a first end 660a, a second end 660c, an outer circumference with a series of ratchet grooves 612, including a stop groove 613, and a hollow interior 660b with a first end 660d. The first end 660d can be closed or can include a vent. The ratchet grooves 612 receive an expandable clip 670 which can ratchet between the grooves 612. When the clip 670 is received within the stop groove 613, the second piston 660 is prevented from extending further out from the housing 502.

Present within the hollow interior 660b is a second piston spring 666 for biasing the second piston 660 outwards from the housing 502. The second piston spring 666 has a first end 666a in contact with the first end 660d of the interior 660b of the second piston 660 and a second end 666b in contact with the bottom 502d of the second axially extending bore 502c or alternatively a check valve. While not shown, a volume reducer may be present within the interior 660b of the second piston 660.

A second high pressure chamber 667 is formed by the hollow interior 660b and the second axially extending bore 502c, within which is the second piston spring 666. Fluid is supplied to the second high pressure chamber 667 through an inlet supply 509 and preferably an inlet check valve 507. Alternatively, the inlet check valves 507, 508 may be ball check valves or disk check valves. The inlet supply 509 may or may not be connected to the inlet supply line 506.

When the tensioner is tensioning a new chain or belt, during operation, fluid is supplied to the first pressure chamber 511 from the first inlet supply 506 and through an inlet check valve 508. This fluid pressure biases the first piston 503 outwards from the housing 502 in addition to the spring force of the first piston spring 504, which applies tension to a span of the closed loop chain or belt through a tensioner arm, such as tensioner arm 402. At the same time, the second piston 660 is also biased outwards from the second axially extending bore 502c by the second piston spring 666 and fluid supplied to the second pressure chamber 667 from the second inlet supply 509 and through inlet check valve 509, which also applies tension to a span of the closed loop chain or belt through the tensioner arm 402 through cap 405 and associated external spring 404.

When the tensioner is tensioning a worn chain or belt without high load, during operation, fluid is supplied to the first pressure chamber 511 through the first inlet supply 506 and through an inlet check valve 508. This fluid pressure biases the first piston 503 outwards from the housing 502 in addition to the spring force of the first piston spring 504, which applies tension to a span of the closed loop chain or belt through the tensioner arm 402. At the same time, the second piston 660 is also biased outwards further through the second piston spring 666. Tension is also maintained by the external spring 404 on the tensioner arm 402. As the chain or belt wears further, additional slack is present in the chain or belt span and the first piston 503 and second piston 660 would need to be extended further outwards from the housing 502 to bias and adequately tension the chain or belt.

When the tensioner is tensioning a chain or belt during high dynamic chain load, the high cyclic dynamic load force from the chain or belt alternately pushes the first piston 503 and the second piston 660 inwards towards the housing 502 and then outwards from the housing 502. Excessive inward movement of the second piston 660 is resisted by the seating of the ratchet clip 670 in the ratchet grooves 612 on the outer circumference of the second piston 660. Inward movement of the first piston 503 is resisted by fluid pressure in the first pressure chamber 511 created by check valve 508. During the low tension portion of the tension cycle, the first piston 503 moves outward by the force of spring 504. This causes the piston to “pump up”, drawing fluid through check valve 508 into the first pressure chamber 511 in the first bore 502a. This causes the first end 503a of the first piston 503 to exert an outward force on the tensioner arm 402 in addition to the force exerted by the second piston 660 through the external spring 404, opposing the inward force of the dynamic load.

When the oil is present, the “pump” up action of the second piston 660 is similar to the first piston 503. When oil is present, the ratchet clip 670 prevents excessive motion. The ratchet clip 670 prevents inward motion of the second piston 660 when no oil is present. This will limit the motion of the tensioner arm 402 and the first piston 503.

When the dynamic chain or belt load decreases, fluid within the second pressure chamber 667 leaks to the engine through the second axially extending bore 502c or through a vent. This leakage reduces the mean pressure present within the second pressure chamber 667.

It should be noted that at all operating conditions, the pressure in the second pressure chamber 667 will pump up to maintain a minimum preload in the external spring 404 on the cap 405. When the force or preload in the external spring 404 gets too low, the second piston 660 moves out from the housing 502, due to the second piston spring 666 and pressure in the second pressure chamber 667 and draws more oil in through the inlet check valve 507.

Therefore, the first piston 503 in the first axially extending bore 502a provides the dominant damping and hydraulic stiffness and the second piston 660 in the second axially extending bore 502c provides the dominant and automatically adjusting spring force through the external spring 404. The tensioner of the present invention automatically adjusts the mean tension force to keep the chain or belt tension as low as possible without sacrificing chain or belt control, significantly improving drive efficiency at new chain or belt conditions and conditions with dynamic loads.

The tensioner of the present invention decreases noise of the tensioner system caused by the second piston by preventing the second piston from contacting or hitting the bottom of the second bore in the housing by the ratchet clip engaging the grooves on the second piston, preventing the external spring from forcing the second piston further into the housing an amount where the second piston contacts the bottom of the bore of the housing.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A passive tensioner system for tensioning a span of a chain or a belt comprising:
a tensioner arm comprising: a body having a first sliding surface in which the chain or belt slides, a second surface opposite the first surface, and a cavity for receiving an external spring; and
a tensioner comprising:
a housing having a first axially extending bore with a first fluid input and a second axially extending bore with a second fluid input;
a first piston slidably received by the first axially extending bore, forming a first pressure chamber in fluid communication with the first fluid input between the first piston and the first axially extending bore, the first piston comprising a body having a first end and a second end;
a first piston spring received within the first pressure chamber between the first piston and the first axially extending bore biasing the first piston away from the housing;
a second piston slidably received within the second axially extending bore, the second piston comprising a body having:
an open end;
a closed end;
a bottom surface at the open end;
a top surface at the closed end;
an outer circumference having a series of grooves extending a length along the outer circumference between the open end and the closed end of the body; and
a hollow interior having an inner diameter;
the second axially extending bore forming a second pressure chamber defined between the inner diameter of the second piston and the second axially extending bore, in fluid communication with the second fluid input through a check valve;
a second piston spring in the second pressure chamber, the second piston spring having a first end in contact with the second piston and a second end in contact with a bottom of the second axially extending bore, biasing the second piston away from the housing;
an expandable clip engaging the series of grooves on the second piston;
wherein when dynamic load from the chain or belt moves the first piston and the second piston inwards and outwards from the housing, fluid from the second fluid input is drawn into the second pressure chamber through the check valve as the second piston is moved outwards from the housing by the second piston spring, and creating a fluid pressure in the second pressure chamber as the second piston moves inward, causing the second piston to exert an outward force on the external spring of the tensioner arm, opposing an inward force of the dynamic load from the tensioner arm;
wherein during engine startup and when oil pressure in the second pressure chamber is low, the second piston is prevented from engaging the second axially extending bore by the expandable clip engaging the series of grooves on the second piston.

2. The tensioner system of claim 1, wherein one of the ratchet grooves is a stop groove.

3. The tensioner system of claim 1, further comprising a first check valve in the first fluid input and a second check valve in the second fluid input.

4. The tensioner system of claim 1, wherein the first fluid input is connected to the second fluid input.

5. The tensioner system of claim 1, wherein the first piston spring has a greater stiffness than the second piston spring.
